(19) United States
(12) Patent Application Publication
(10) Pub. No.: US 2011/0006168 A1
(43) Pub. Date: Jan. 13, 2011

(54) SUPPORT RAILS

(75) Inventors: JEFFREY T. PALLITTO, Greensburg, PA (US); Shannon Pallitto, Greensburg, PA (US)

Correspondence Address: ECKERT SEAMANS CHERIN & MELLOTT, 600 GRANT STREET, 44TH FLOOR, PITTSBURGH, PA, 15219, US

(73) Assignee: Spectrum Metal Solutions, LLC, Greensburg, PA (US)

(21) Appl. No.: 12/884,884

(22) Filed: Sep. 17, 2010

Related U.S. Application Data
(63) Continuation-in-part of application No. 11/725,876, filed on Mar. 20, 2007.

(51) Int. Cl. F16L 3/00

(52) U.S. Cl. 248/49

(57) ABSTRACT

A support rail structured to support a plurality of rods for transport. The support rail has an elongated body with an elongated passage therethrough. The body has a cross-sectional shape resembling two trapezoids coupled along their minor bases with the upper trapezoid being smaller than the lower trapezoid. Passages extend longitudinally through each trapezoidal portion of the body. The passage through the upper portion is structured to accommodate the band. The passage in the lower portion is divided into sub-passages by at least one support. The band is passed through the first passage and wrapped about the rods.

### CROSS REFERENCE TO RELATED APPLICATION

This application is a continuation-in-part and claims priority under 35 U.S.C. §119(e) to U.S. patent application Ser. No. 11/725,876, filed Mar. 20, 2007, entitled, SUPPORT RAILS.

### BACKGROUND OF THE INVENTION

1. Field of the Invention

This invention relates to support rails for transporting bundles of elongated rods and, more specifically, to support rails having an internal passage for banding members.

2. Background Information

Unlike many compact items which may be disposed upon square pallets for transport, “long product,” e.g. pipes, poles, bars, posts, shafts, etc., collectively hereinafter, “rods” are typically disposed upon a board supported by two or more support rails. Typically, a support rail is a simple, yet sturdy and heavy piece of wood. The support rails provide clearance for devices, such as forklifts, to pick up and move the bundle. The rod or rods are oriented to be generally parallel to each other and then disposed upon the generally perpendicular support rails. One support rail is disposed adjacent to each end of the bundle of rods. The rods are then secured to the support rails by a band of material, typically steel. The band extends longitudinally under a support rail and is passed over the rods and tightened.

While such support rails are inexpensive, they suffer from at least one major disadvantage; the band tends to break due to the compressive force of the bands or when a perpendicular force is applied thereto. That is, the bands may be applied at a tension that exceeds the compressive strength of the wood. Further, the shipping bundle, i.e. the rods secured to at least two support rails, are typically transported by a truck having an elongated bed. The rods are disposed parallel to the axis of the bed and thus, the support rails are disposed generally perpendicular to the axis of the bed. When the shipping bundle is being removed from the truck, workers tend to pull the shipping bundle in the direction of the longitudinal axis of the bed. It is at this time that the bands tend to break, or slip off the support rails, thereby allowing the rods to fall off the support rails or otherwise become separated.

There is, therefore, a need for a shipping rail that is structured to resist the breaking of the band.

There is a further need for a shipping rail that is light but strong.

### SUMMARY OF THE INVENTION

These needs, and others, are met by at least one embodiment of the claimed invention which provides for a support rail having a passage for the band. That is, the support rail has an elongated body with an upper surface. Just below the upper surface is a first passage structured to allow the band to pass therethrough. The band is passed through the first passage and wrapped about the rods. The support rail is made from a slightly compressible composite material. As such, when a band is passed through the first passage and tightened, the support rail compresses slightly thereby reducing the stress of the band at the end of the support rail. That is, the material forming the passage does not form a right angle when the band is in tension, thus there is less stress on the band when compared to a rigid support rail having a band pass over a right angle.

The support rail is preferably made from a sturdy material such as steel, a steel alloy, aluminum, plastic, or a composite material. Steel and steel alloys tend to be heavy and composite materials tend to be expensive and may also be heavy. Thus, the disclosed support rail further provides for a second passage. By eliminating the material that would fill the second passage both the weight and the cost of the support rail is reduced. The second passage may include a support matrix or support members for added strength.

### BRIEF DESCRIPTION OF THE DRAWINGS

A full understanding of the invention can be gained from the following description of the preferred embodiments when read in conjunction with the accompanying drawings in which:

FIG. 1 is an end view of a shipping bundle.

FIG. 2 is a side view of a shipping bundle.

FIG. 3 is a cross sectional side view of a support rail.

FIG. 4 is a cross sectional side view of an alternate embodiment of a support rail. FIG. 4A is a detailed view of the first passage.

FIG. 5 is a cross sectional side view of an alternate embodiment of a support rail. FIG. 5A is a detailed view of the first passage.

FIG. 6 is a cross sectional side view of an alternate embodiment of a support rail. FIG. 6A is a detailed view of the first passage.

FIG. 7 is a cross sectional side view of an alternate embodiment of a support rail.

FIG. 8 is a cross sectional side view of an alternate embodiment of a support rail. FIG. 8A is a detailed view of the first passage.

FIG. 9 is a cross sectional side view of an alternate embodiment of a support rail.

FIG. 10 is an isometric view of a support rail.

FIG. 11 is an end view of an alternate embodiment of a support rail.

FIG. 12 is a cross sectional side view of an alternate embodiment of a support rail.

FIG. 13 is an isometric view of another embodiment of the invention.

FIG. 14 is a cross-sectional view of the embodiment shown in FIG. 13.

### DESCRIPTION OF THE PREFERRED EMBODIMENTS

As used herein, the phrase “structured to allow the band to pass therethrough” when used to describe a passage and/or describing a passage as “sized to accommodate the band” means that the passage is slightly wider and thicker than the associated band. This feature ensures that the band does not shift forward and aft, as described below.

As used herein, the word “unitary” means a component is created as a single piece or unit. That is, a component that includes pieces that are created separately and then coupled together as a unit is not a “unitary” component or body.

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

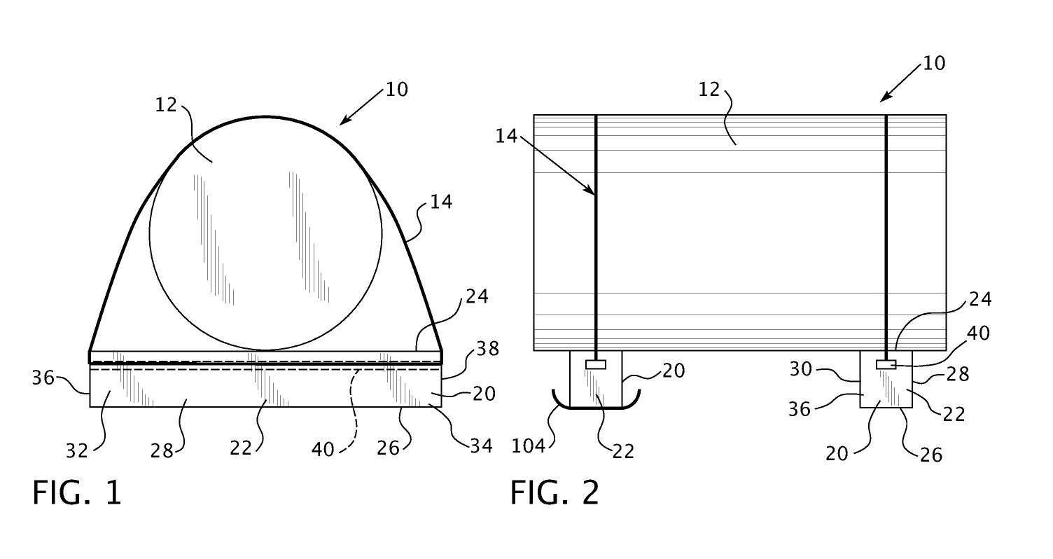

As shown in FIGS. 1 and 2, a shipping bundle 10 includes one or more elongated rods 12 disposed upon at least two support rails 20. The rods 12 are secured to the support rails 20 by a band 14. The band 14 is, preferably a steel band 14 having a width of between about 0.250 in. and 1.250 in., and more preferably about 0.750 in. and a thickness of between about 0.020 in. and 0.060, and more preferably about 0.040 in. The support rails 20 and the bands 14 extend generally perpendicular to the longitudinal axis of the rods 12. The following description shall address a single support rail 20, however, it is understood that both support rails 20 have similar features.

The support rail 20 includes an elongated body 22 having an upper surface 24, a bottom surface 26, a first side surface 28 and a second side surface 30. The upper surface 24 and the bottom surface 26 each have a width and are generally parallel to each other. The width of the upper surface 24 and the bottom surface 26 is preferably between about 2.0 in. and 6.0 in., and more preferably about 3.0 in. The first side surface 28 and the second side surface 30 each have a height and area also generally parallel to each other. The height of the first side surface 28 and the second side surface 30 is preferably between about 4.0 in. and 6.0 in., and more preferably about 4.0 in. Thus, the support rail 20 has a cross-sectional shape that is generally a parallelogram. The support rail body 22 also has a first end 32 and a second end 34. At the first end 32 is a first face 36 that is a generally planar surface extending generally perpendicular to the longitudinal axis of the support rail body 22. At the second end 34 is a second face 38 that is a generally planar surface extending generally perpendicular to the longitudinal axis of the support rail body 22. Between the first face 36 and the second face 38, the support rail body 22 has a length of between about 12.0 in. and 72.0 in., and more preferably about 36.0 in.

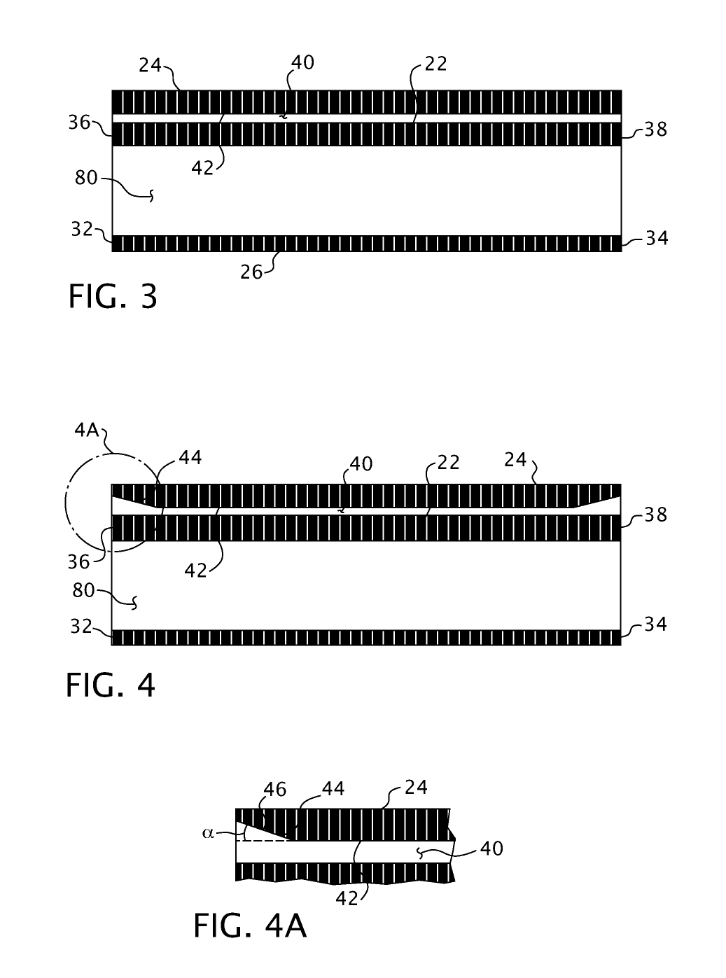

Extending longitudinally through the support rail body 22 is a first passage 40. The first passage 40 is, preferably sized to accommodate the band 14. That is, the first passage 40 preferably has a width of between about 1.0 in. and 1.5 in., and more preferably about 1.25 in. and a height of between about 0.1 in. and 0.3 in., and more preferably about 0.25 in. As shown in FIG. 3, the first passage 40 has an upper, interior surface 42 adjacent to the body upper surface 24. The upper, interior surface 42 has a stress reduction surface 44 adjacent to both the body first end 32 and the body second end 34. In the two preferred embodiments, the stress reduction surface 44 is either an angled portion 45 or a curved portion 60 of the upper, interior surface 42.

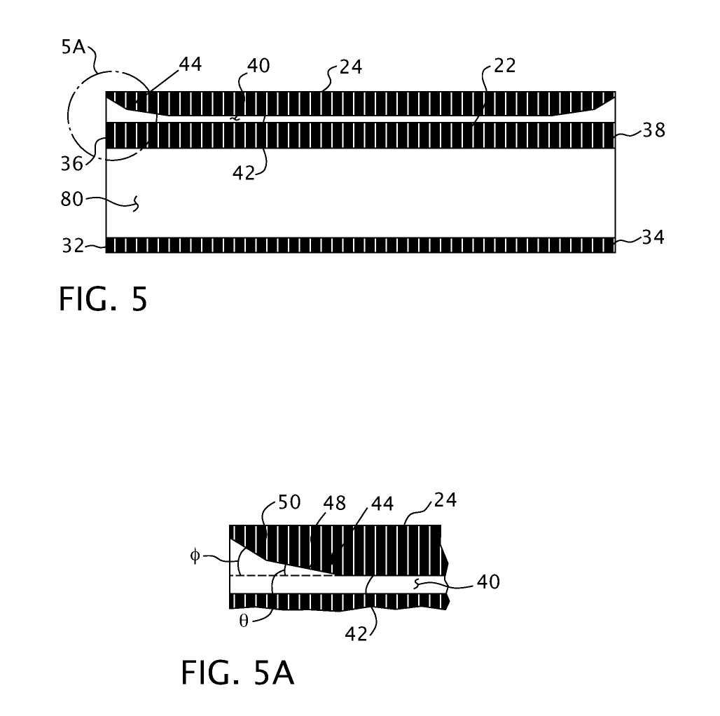

In one embodiment, shown in FIGS. 4 and 4A, the upper, interior surface 42 is generally planar and each stress reduction surface 44 is an angled portion 45 adjacent to both the body first end 32 and the body second end 34. That is, each stress reduction surface 44 includes at least one generally planar surface 46 extending in a plane that is at an acute angle, represented by the symbol a in FIG. 4A, relative to the longitudinal axis of the body 22. In another embodiment, shown in FIGS. 5 and 5A, each stress reduction surface 44 has a first planar surface 48 and a second planar surface 50. Each first planar surface 48 extends in a plane that is at a first acute angle, represented by the symbol ν in FIG. 5A, relative to the longitudinal axis of the body 22. Each said second planar surface 50 extends in a plane that is at a second acute angle, represented by the symbol φ in FIG. 5A, relative to the longitudinal axis of the body 22. Further, the stress reduction surface 44 may have three or more angled surfaces within the first passage 40.

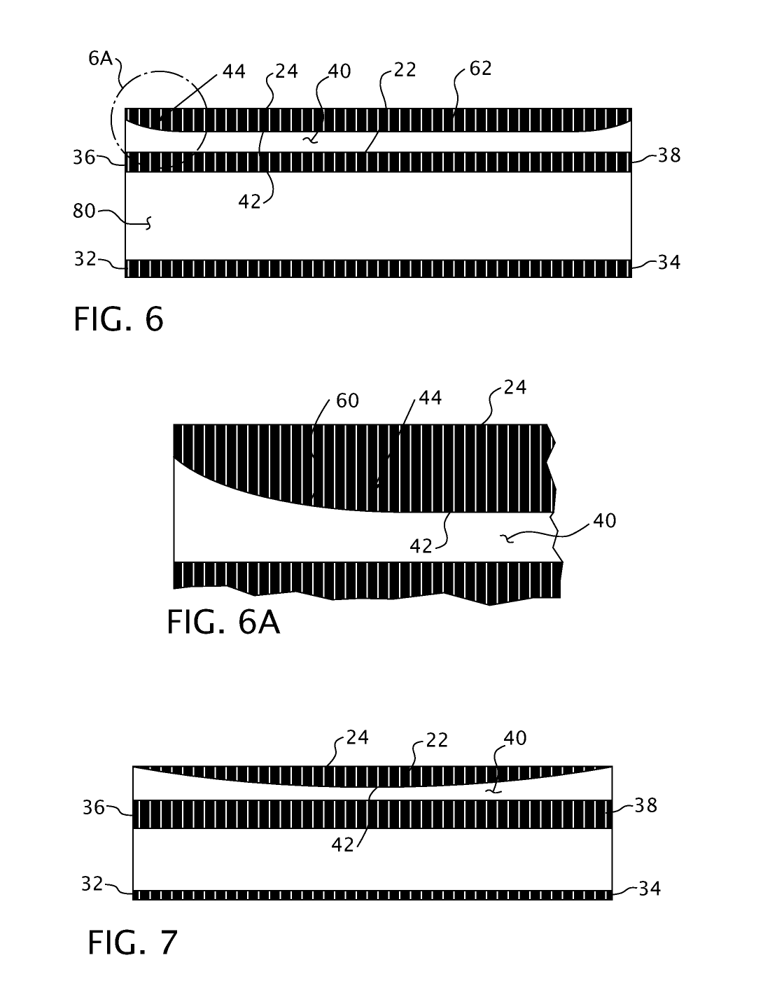

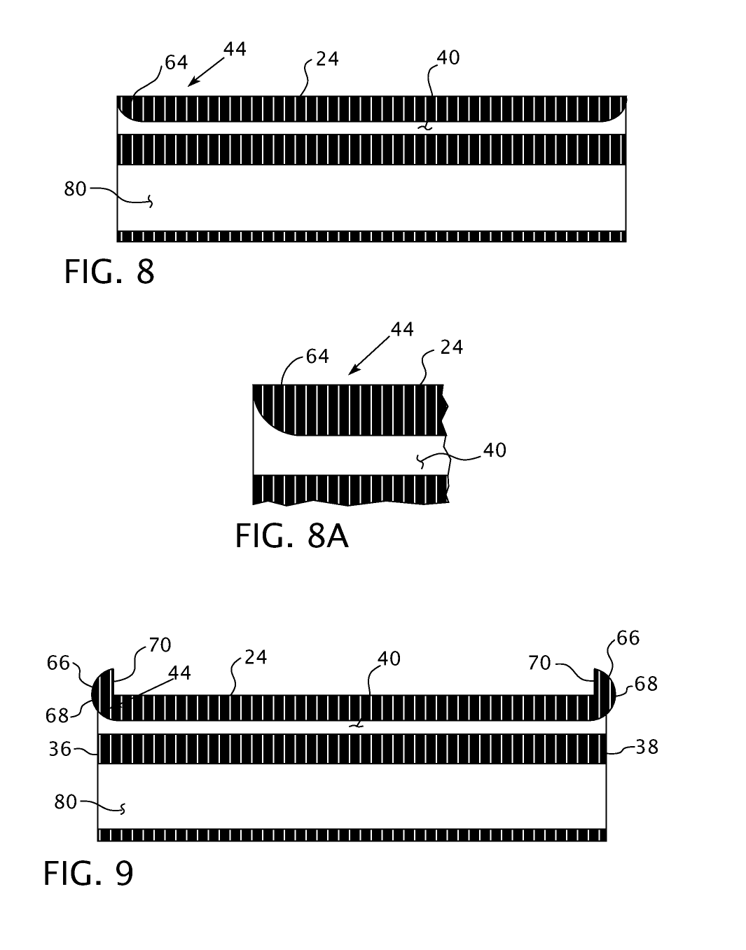

In another embodiment, shown in FIGS. 6 and 6A, each stress reduction surface 44 is a curved portion 60 of the upper, interior surface 42 adjacent to each end face 36, 38. While the entire upper, interior surface 42 may be shaped as an arc, as shown in FIG. 7, in a preferred embodiment, shown in FIG. 6, the upper, interior surface 42 includes a generally planar medial portion 62 and a curved portion 60 extending between the medial portion 62 and each end face 36, 38. As shown in FIG. 6 the curved portion 60 may extend over a length of the first passage 40 and have a variable radius of curvature. Alternatively, as shown in FIGS. 8 and 8A, the curved portion 60 may be localized to a small portion of the first passage 40. When the curved portion 60 is localized, it is preferably a generally circular arc 64.

A further enhancement, shown in FIG. 9, provides for the stress reduction surface 44 to extend over the first face 36 and the second face 38. That is, the first face 36 and the second face 38 may include a curved extension or “bulge” 66. Each bulge 66 provides a curved outer surface 68. Another enhancement, also shown in FIG. 9, is an upwardly extending flange 70 disposed at both the body first end 32 and the body second end 34. Each flange 70 assists in maintaining the rods 12 on the body upper surface 24. Further, each bulge 66 may, or may not, extend to the top of each flange 70.

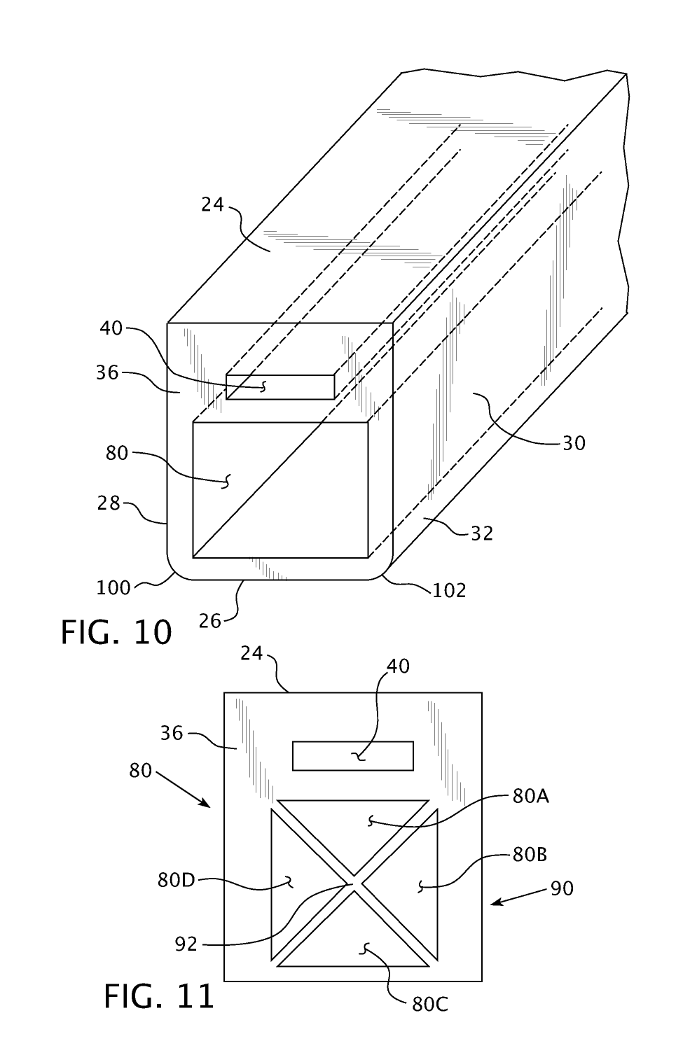

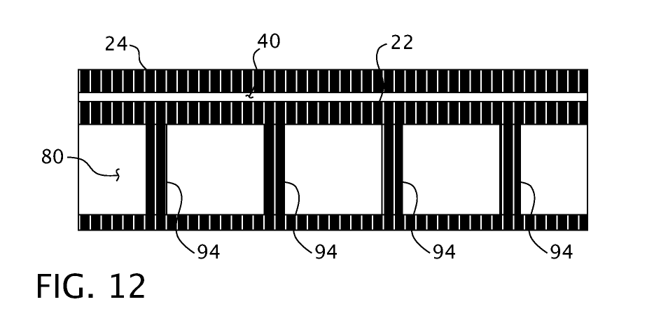

As shown in FIG. 10, the support rail body 22 may also include at least one second passage 80. The at least one second passage 80 is primarily a weight reduction device but may also be used to provide additional strength to the body 22. As noted above, the support rail body 22 is most preferably about 3.0 in. wide and about 4.0 in. high. The at least one second passage 80 preferably has a cross-sectional area of about 50% the size of the body 22 cross-sectional area. The at least one second passage 80 may be empty, as shown in FIG. 10, or, as shown in FIGS. 11-12, the at least one second passage 80 may include a support structure 90. The support structure 90 is structured to substantially resist the deformation of support rail body 22. The support structure 90 may be integral with the support rail body 22 or may be one or more separate elements. For example, where the support rail body 22 is made using an extrusion process, the at least one second passage 80 may include a plurality of passages 80A, 80B, 80C, 80D wherein the configuration of the plurality of passages 80A, 80B, 80C, 80D define a support structure 90 such as a cross brace 92 as shown in FIG. 11. In this embodiment, the support structure 90, that is the cross brace 92 extends the length of the plurality of passages 80A, 80B, 80C, 80D. In an alternate embodiment, shown in FIG. 12, the support rail body 22 is formed as a generally solid body and the at least one second passage 80 is milled therefrom. In this embodiment, the support structure 90 may be one or more separate support elements 94 that are inserted into, and coupled to, the at least one second passage 80. The separate support elements 94 are, preferably, a plurality of generally flat, plate-like members that are spaced along the at least one second passage 80. Alternatively, the separate support element 94 may be an elongated member, either solid or hollow, that is inserted into the at least one second passage 80. For example, a support rail body 22 made from an extruded plastic and having a single second passage 80 may have a steel pipe inserted for extra strength.

The present invention further provides for a configuration structured to allow the support rail body 22 to be moved more easily in a direction perpendicular to the longitudinal axis of the support rail body 22. For example, as shown in FIG. 10, a first corner 100 at the interface of the bottom surface 26 and the first side surface 28 and a second corner 102 at the interface of the bottom surface 26 and the second side surface 30 may be rounded. Alternatively, as shown in FIG. 2, the bottom surface 26 may include one or more runners 104 similar to a sled.

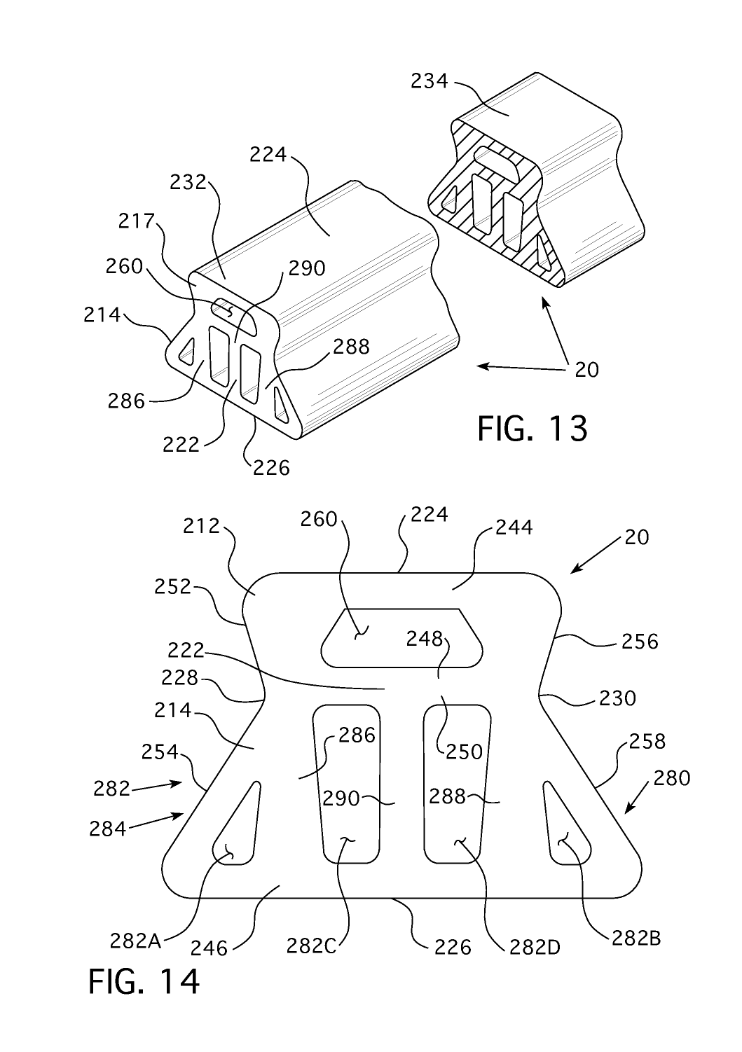

The support rail 20 may also include an elongated body 222 as shown in FIGS. 13 and 14. In this embodiment, the support rail body 222 has an upper surface 224, a bottom surface 226, a first end 232 and a second end 234, as before. The first side surface 228 and a second side surface 230, are indented. That is, the first side surface 228 and a second side surface 230 are concave. Further, the upper surface 224 has a width that is less than the width of the bottom surface 226. In this configuration, the cross-section of the support rail body 222 appears as two trapezoids; an upper, inverted trapezoidal first portion 212 and a lower, trapezoidal second portion 214.

The following discussion details the cross-sectional shape of the support rail body 222, as shown in FIG. 14. It is understood that the cross-sectional shape of the support rail body 222 is substantially consistent along the longitudinal length of the support rail body 222. The trapezoidal portions 212, 214 are each, preferably, isosceles trapezoids. Each trapezoidal portion 212, 214 has a major base 244, 246 (respectively), a minor base 248, 250 (respectively), a first side 252, 254 (respectively), and a second side 256, 258 (respectively). The outer surface of the second portion major base 246 is the support rail body bottom surface 226. The outer surface of the first portion major base 244 is the support rail body upper surface 224. That is, the trapezoidal portions 212, 214 are joined along each trapezoidal portions' minor base 248, 250. The second portion 214 is an “upright” trapezoid having its major base 246 oriented below its minor base 250. Thus, the first portion 212 is “inverted” having the first portion major base 244 above the first portion minor base 248. The outer surface of the both portions first sides 252, 254 is the support rail body first side surface 228 and the outer surface of the both portions second sides 256, 258 is the support rail body second side surface 230. While identifying the distinct portions 212, 214 of the support rail body 222 by separate names, the support rail body 222 is, preferably, a unitary body, as discussed below.

The first portion 212 defines a first passage 260. The first passage 260 is an enclosed passage, i.e. the support rail body 222 encircles the passage 260. Put another way, an enclosed passage is not a groove or channel. As before, the first passage 260 extends longitudinally through the support rail body 222 adjacent to the support rail body upper surface 224. The passage 260 is structured to allow a band 14 to pass therethrough.

The second portion 214, preferably, defines a second passage 280. Thus, the second passage 280 extends longitudinally through the support rail body 222. The second passage is preferably divided into sub-passages 282. That is, there is at least one support 284, which is preferably an elongated substantially vertical support 284 (when viewed in cross-section), extending between the second portion major base 246 and the second portion minor base 250. More preferably, the at least one support 284 includes a first and second support 286, 288. The first support 286 is disposed at one end of said second portion minor base 250 (when viewed in cross-section). The second support 288 is disposed at the other end of the second portion minor base 250. The at least one support 284 may also include a medial support 290 disposed at a medial location on the second portion minor base 250. Preferably, the first and second support 286, 288 (when viewed in cross-section) are wider at the base than at the top. That is, the first support 286 is wider at the second portion major base 246 than at the second portion minor base 250. Similarly, the second support 288 is wider at the second portion major base 246 than at the second portion minor base 250.

In the preferred configuration having three (first, medial, and second) supports 286, 288, 290, the second passage 280 is divided into four sub-passages 282. A first sub-passage 282A exists between the second portion first side 254 and the first support 286. A second sub-passage 282B exists between the second portion second side 258 and the second support 288. A third sub-passage 282C exists between the first support 286 and the medial support 290. A fourth sub-passage 282D exists between the second support 288 and the medial support 290.

In this configuration, the support rail body 222 is structured to support a heavy load with an acceptable and controlled deformation. That is, the support rail body 222 is, preferably, made from a composite material that includes polypropylene and wood fiber at a ratio of between about 70% to 30%, and 50% to 50% and more preferably at a ratio of about 60% to 40%. This composite material is structured to deform under stress and preferably has a Rockwell R hardness of about 80 to about 110, and more preferably of about 95. This deformability allows the first portion major base 244, adjacent to the support rail body first and second ends 232, 234, to deform (compress) when the band 14 is tightened about the rods 12. This reduces the stress on the band 14 compared to a rigid corner, e.g. a corner on a wood support rail.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A support rail for use in a shipping bundle, said bundle including an elongated, flexible band, said support rail comprising:
an elongated body having an upper surface, a first end, and a second end; and
a first passage extending longitudinally through said body adjacent to said upper surface, said passage structured to allow said band to pass therethrough.

2. The support rail of claim 1 wherein:
said body includes two portions, an upper, inverted trapezoidal first portion and a lower, trapezoidal second portion;
each of said first and second portions having an external major base and an internal minor base;
said first and second portions joined along their respective minor bases; and
said passage extending through said first portion.

3. The support rail of claim 2 wherein:
said second portion includes a second passage extending longitudinally through said body;
said second passage divided into sub-passages by at least one substantially vertical support extending between said second portion major base and said second portion minor base.

4. The support rail of claim 3 wherein:
said at least one support includes a first and second support;
said first support disposed at one end of said second portion minor base; and
said second support disposed at the other end of said second portion minor base.

5. The support rail of claim 4 wherein:
said at least one support includes a medial support; and
said medial support disposed at a medial location on said second portion minor base.

6. The support rail of claim 5 wherein the major base of said first portion is smaller than the major base of said second portion.

7. The support rail of claim 6 wherein:
said second portion has a first side and a second side; and
wherein a first sub-passage exists between said second portion first side and said first support;
a second sub-passage exists between said second portion second side and said second support;
a third sub-passage exists between said first support and said medial support; and
a fourth sub-passage exists between said second support and said medial support.

8. The support rail of claim 7 wherein:
said first support is wider at the second portion major base than at the second portion minor base; and
said second support is wider at the second portion major base than at the second portion minor base.

9. The support rail of claim 8 wherein said body is made from a composite material.

10. The support rail of claim 9 wherein said composite material includes polypropylene and wood fiber at a ratio of between about 70% to 30%, and 50% to 50%.

11. The support rail of claim 10 wherein said composite material includes polypropylene and wood fiber at a ratio of about 60% to 40%.

12. The support rail of claim 4 wherein:
said second portion has a first side and a second side; and
wherein a sub-passage exists between said second portion first side and said first support; and
a sub-passage exists between said second portion second side and said second support.

13. The support rail of claim 12 wherein:
said first support is wider at the second portion major base than at the second portion minor base; and
said second support is wider at the second portion major base than at the second portion minor base.

14. The support rail of claim 13 wherein said body is made from a composite material.

15. The support rail of claim 4 wherein said composite material includes polypropylene and wood fiber at a ratio of between about 70% to 30%, and 50% to 50%.

16. The support rail of claim 15 wherein said composite material includes polypropylene and wood fiber at a ratio of about 60% to 40%.

17. The support rail of claim 3 wherein:
said at least one support includes a medial support; and
said third support disposed at a medial location on said upper portion minor side.

18. The support rail of claim 1 wherein said composite material includes polypropylene and wood fiber at a ratio of between about 70% to 30%, and 50% to 50%.

19. The support rail of claim 18 wherein said composite material includes polypropylene and wood fiber at a ratio of about 60% to 40%.
